(19) United States
(12) Patent Application Publication
(10) Pub. No.: US 2009/0107581 A1
(43) Pub. Date: Apr. 30, 2009

(54) Combination Scoop-Funnel Device

(76) Inventor: Larry Sayage, Muttontown, NY (US)

Correspondence Address: ROSENFELD LAW CORPORATION, 1638 FILBERT STREET, SAN FRANCISCO, CA, 94123, US

(21) Appl. No.: 12/201,182

(22) Filed: Aug. 29, 2008

Related U.S. Application Data
(60) Provisional application No. 60/968,859, filed on Aug. 29, 2007.

(51) Int. Cl. A47J 43/28; B67C 11/02

(52) U.S. Cl. 141/98; 141/331; 294/55

(57) ABSTRACT

A combination scoop-funnel device has a scoop shaped member and a funnel shaped member. The members are removably attached to each other by a ring protrusion on the scoop shaped member and a ring receptor on the funnel shaped member that create a ring snap when the members are pressed together.

### FIELD OF THE INVENTION

The present invention relates generally to a combination scoop-funnel device, and more particularly to a scoop-funnel device for inclusion in canisters of powdered nutritional supplements.

### BACKGROUND OF THE INVENTION

There has been an explosion in bottled water use in the United States, driven in large measure by marketing designed to convince the public of bottled water's purity and safety, and capitalizing on public concern about tap water quality. Health conscience consumers of bottled water have become increasingly interested in adding nutritional supplements to their bottled water, such as protein powder, energy supplements and vitamin supplements.

Supplements typically come in powdered form and are sold in either large canisters or in single or multiple serving pouches. For large canisters, a scoop is often provided by the manufacturer for the consumer to transfer the powder into a container of water.

The transfer of powder is relatively easy when using a drinking glass as the container. However, the exercise is more challenging when transferring the powder into a bottled water container. The small opening of the bottled water container usually results in powder being spilled.

One option for pouring powders into small openings is a funnel. The narrow end is placed in the receptacle and the powder is placed in the wide end. While funnels are a common household item, the funnel must be located for each use and may not be readily available. This results in wasted time for consumers.

The present invention seeks to solve these problems by providing a convenient portable device configured for inclusion in containers of powdered nutritional supplements along for pouring the powdered nutritional supplements into a bottled water container.

### SUMMARY OF THE INVENTION

One aspect of the present invention is a combination scoop-funnel device having a scoop section and a funnel section configured to be detachable from each other.

Other objects and advantages, which are set forth in the description of the Detailed Description of the Invention. The features and advantages described in the specification, however, are not all inclusive, and particularly, many additional features and advantages will be apparent to one of ordinary skill in the art in view of the drawings and specification herein.

### BRIEF DESCRIPTION OF THE DRAWINGS

FIG. 1 is a front cross-sectional view of the scoop-funnel device with the scoop and funnel detached for use.

FIG. 2 is a front cross-sectional view of the scoop-funnel device with the scoop and funnel attached for storage in a powdered nutritional supplement container.

FIG. 3 is an enlarged view of the ring snap section shown in FIG. 2.

### DETAILED DESCRIPTION

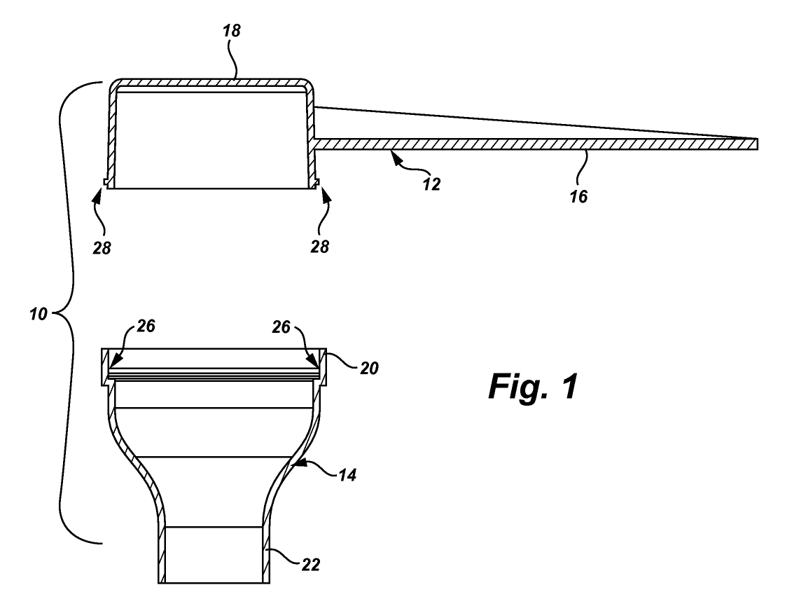

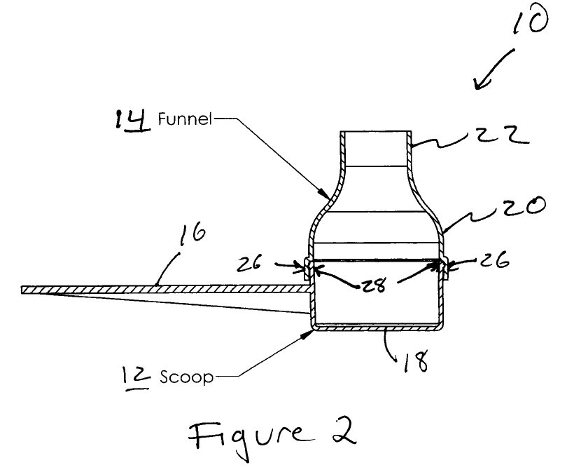

The preferred embodiment is a combination scoop-funnel device 10 as shown in FIGS. 1 and 2. Scoop-funnel device 10 includes scoop portion 12 and funnel portion 14. Scoop portion 12 has a handle section 16 and cup section 18. Funnel portion 14 has a mouth section 20 and stem section 22.

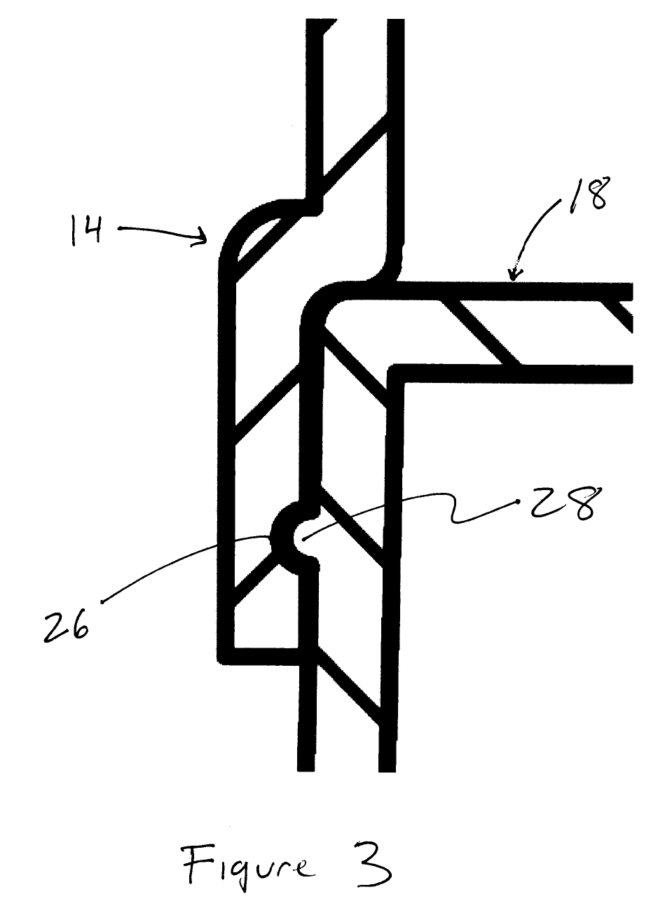

Scoop portion 12 and funnel 14 are attachable by way of a ring snap formed by ring 24 on scoop portion 12 and receptor 26 on funnel portion 14. As shown in FIGS. 2 and 3, when scoop portion 12 and funnel portion 14 are attached, receptor 26 accepts ring 28 to hold scoop portion 12 and funnel portion 14 together. Scoop-funnel device 10 is detached for use by pulling scoop portion 12 and funnel portion 14 apart with sufficient force to release the ring snap.

Scoop-funnel device 10 is attached for storage in a powdered nutritional supplement container. By storing scoop-funnel device 10 in its attached state, scoop-funnel device 10 is more easily located by a consumer digging through the powder in the container. This avoids the need for trying to locate two separate pieces, which in turn saves time and reduces the chances of spilling powder from the container.

In use, consumers separate scoop portion 12 from funnel portion 14. Then, holding handle section 16, scoop out a desired amount of powder with cup section 18. Instead of trying to pour the powdered directly into a bottled water container, which will likely result in spilled powder, stem section 22 of funnel portion 14 is placed into the bottled water container. Then, the powder is poured from cup section 18 into mouth section 20 of funnel portion 14.

Scoop-funnel device 10 is preferably formed of PETE plastic material (preferably polypropylene or polyethylene) by an injection molding process, although other materials and processes may be used. Further, scoop-funnel device 10 is sufficiently rigid to hold its shape when in use as a funnel, and yet, sufficiently flexible to expand slightly to allow the creation and release of the ring snap.

From the above description, it will be apparent that the invention disclosed herein provides a novel and advantageous a scoop-funnel device for use with powdered nutritional supplement containers and bottled water containers. The foregoing discussion discloses and describes merely exemplary methods and embodiments of the present invention. One skilled in the art will readily recognize from such discussion that various changes, modifications and variations may be made therein without departing from the spirit and scope of the invention.

I claim:

1. An apparatus comprising:
a scoop shaped member having a handle section, a cup section, and a ring protrusion on the cup section; and
a funnel shaped member having a mouth section, a stem section, and a ring receptor on;
wherein the ring protrusion is removably attachable to the ring receptor to form a ring snap when the cup section of the scoop shaped member and the mouth section of the funnel shaped member are pressed together.

2. The apparatus of claim 1, wherein the funnel shaped member and the scoop shaped member are detachable for use by pulling the funnel shaped member and the scoop shaped member apart with sufficient force to release the ring snap.
